(19) United States
(12) Patent Application Publication
(10) Pub. No.: US 2020/0014620 A1
(43) Pub. Date: Jan. 9, 2020

(54) VEHICLE NETWORK APPARATUS AND OPERATION METHOD THEREOF

(71) Applicant: LG Electronics Inc., Seoul (KR)

(72) Inventor: Minsu KIM, Seoul (KR)

(21) Appl. No.: 16/575,028

(22) Filed: Sep. 18, 2019

(30) Foreign Application Priority Data
Aug. 9, 2019 (KR) 10-2019-0097355

(51) Int. Cl. H04L 12/721; H04L 12/66; H04L 12/46; H04L 29/06

(52) U.S. Cl. CPC H04L 45/38; H04L 45/70; H04L 2012/40215; H04L 12/4625; H04L 29/06; H04L 12/66

(57) ABSTRACT

Provided is a vehicle network apparatus including a plurality of SDN switches and a gateway configured to identify a route for transmitting data of a device connected to at least one software defined network (SDN) switch among the plurality of switches and control the plurality of SDN switches so that the data is transmitted based on the identified route, and an operation method thereof. In the present disclosure, at least one of the vehicle network apparatus, a vehicle, and an autonomous vehicle may operate in association with an artificial intelligence (AI) module, an unmanned aerial vehicle (UAV), a robot, an augmented reality (AR) device, a virtual reality (VR) device, and a 5G service-related device, for example.

### CROSS-REFERENCE TO RELATED APPLICATION

This application claims priority under 35 U.S.C. § 119(a) to Korean Patent Application No. 10-2019-0097355, filed on Aug. 9, 2019, the disclosure of which is incorporated herein in its entirety by reference.

### BACKGROUND

### 1. Field

The present disclosure relates to a vehicle network apparatus and an operation method thereof and, more particularly, to a software defined network (SDN)-based vehicle network apparatus and an operation method thereof.

### 2. Description of the Related Art

In-vehicle devices are increasing as a function of a vehicle is diversified and evolved. Vehicle network devices for managing the in-vehicle devices are also increasing. Accordingly, there is a desire for a vehicle network device for effectively managing the in-vehicle devices.

An autonomous vehicle refers to a vehicle equipped with an autonomous driving device that recognizes an environment around the vehicle and a state of the vehicle and controls driving of the vehicle based on the environment and the state. With progresses in research on autonomous vehicles, studies on various services that may increase a user's convenience using the autonomous vehicle are also in progress.

### SUMMARY

The present disclosure provides a vehicle network apparatus and an operation method thereof. Technical goals to be achieved through the example embodiments are not limited to the technical goals as described above, and other technical tasks can be inferred from the following example embodiments.

According to an aspect, there is provided a software defined network (SDN)-based vehicle network apparatus including a plurality of SDN switches and a gateway configured to identify a route for transmitting data of a device connected to at least one SDN switch among the plurality of switches and control the plurality of SDN switches so that the data is transmitted based on the identified route.

According to another aspect, there is also provided an operation method of an SDN-based vehicle network apparatus, the method including identifying a route for transmitting data of a device connected to at least one SDN switch among a plurality of switches in the SDN-based vehicle network apparatus and controlling the plurality of SDN switches so that the data is transmitted based on the identified route.

According to still another aspect, there is also provided a non-transitory computer-readable storage medium including a non-volatile memory that stores programs to execute the operation method described above.

Specific details of example embodiments are included in the detailed description and drawings.

According to example embodiments, it is possible to provide a vehicle network apparatus that identifies a route suitable for transmitting data of a device using a gateway functioning as an SDN controller and controls a plurality of SDN switches based on the identified route. Also, the vehicle network apparatus may effectively implement a network failover using the gateway and the plurality of SDN switches.

Effects are not limited to the aforementioned effects, and other effects not mentioned will be clearly understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate examples of an autonomous vehicle operation using 5G communication.

FIG. 7 illustrates a vehicle network apparatus according to the present disclosure;

FIG. 8 illustrates an example of a vehicle network apparatus;

FIG. 9 illustrates another example of a vehicle network apparatus;

FIG. 10 illustrates an example of a gateway changing a data transmission route;

FIG. 11 illustrates another example of a gateway changing a data transmission route;

FIG. 12 illustrates an example of a gateway blocking data of a device;

FIG. 13 illustrates an example of a gateway communicating with an external network;

FIG. 14 illustrates an example of a vehicle network apparatus communicating with an artificial intelligence (AI) server; and

FIG. 15 illustrates an operation method of a vehicle network apparatus according to the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The terms used in the embodiments are selected, as much as possible, from general terms that are widely used at present while taking into consideration the functions obtained in accordance with the present disclosure, but these terms may be replaced by other terms based on intentions of those skilled in the art, customs, emergency of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

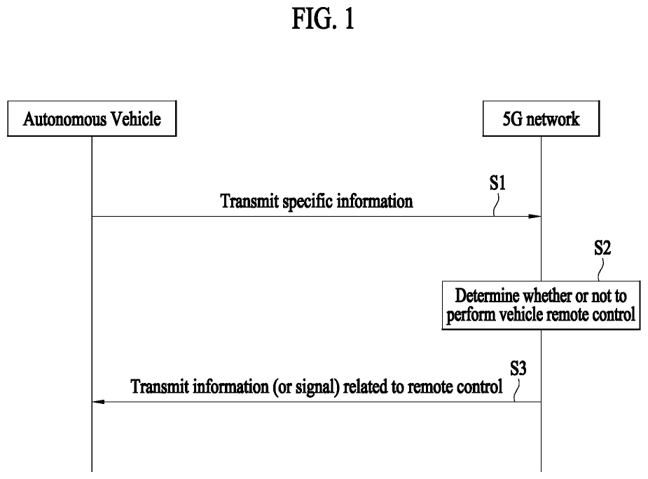

FIG. 1 illustrates an example of a basic operation of an autonomous vehicle and a 5G network in a 5G communication system.

In step S1, the autonomous vehicle transmits specific information to the 5G network which is based on a fifth generation cellular network technology.

The specific information may include information related to autonomous driving.

The information related to autonomous driving may be information that is directly related to vehicle driving control. For example, the information related to autonomous driving may include at least one of object data indicating an object around a vehicle, map data, vehicle state data, vehicle location data, and driving plan data. The information related to autonomous driving may further include, for example, service information required for autonomous driving.

In step S2, the 5G network may determine whether or not to perform vehicle remote control. Here, the 5G network may be connected to a server or a module which performs remote control related to autonomous driving, or may include such a server or module.

In step S3, the 5G network may transmit information (or signals) related to remote control to the autonomous vehicle.

As described above, the information associated with the remote control may be a signal directly applied to the autonomous vehicle and may additionally include service information required for autonomous driving. In an example embodiment of the present disclosure, the autonomous vehicle may receive data for operating a vehicle network apparatus through a server connected to the 5G network. Also, the autonomous vehicle may receive, from an external source, information on a data transmission route in the vehicle network apparatus.

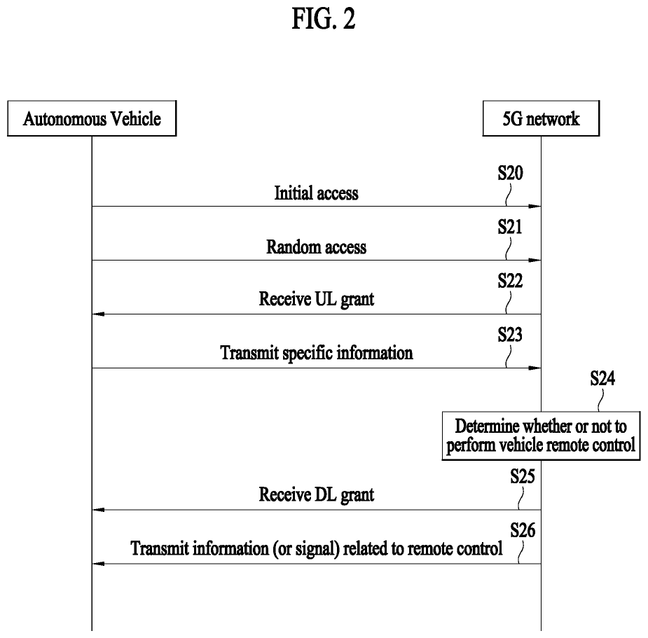

Hereinafter, a process required for 5G communication between an autonomous vehicle and a 5G network (for example, an initial access process between the vehicle and the 5G network) will be schematically described with reference to FIGS. 2 to 6, in order to provide or receive a traveling image for a specific route.

FIG. 2 illustrates an example of an application operation of an autonomous vehicle and a 5G network in a 5G communication system.

In step S20, the autonomous vehicle performs an initial access process with the 5G network.

The initial access process includes, for example, a cell search process for the acquisition of a downlink (DL) operation and a process of acquiring system information.

In step S21, the autonomous vehicle performs a random access process with the 5G network.

The random access process includes, for example, preamble transmission and random access response reception processes for the acquisition of uplink (UL) synchronization or the transmission of UL data.

In step S22, the 5G network transmits an UL grant for scheduling the transmission of specific information to the autonomous vehicle (S22).

The reception of the UR grant includes a process of receiving a time and frequency resource schedule for the transmission of UL data to the 5G network.

In step S23, the autonomous vehicle transmits specific information to the 5G network based on the UL grant.

In step S24, the 5G network determines whether or not to perform vehicle remote control.

In step S25, the autonomous vehicle receives a DL grant from the 5G network through a physical downlink control channel in order to receive a response to the specific information.

In step S26, the 5G network transmits information (or signals) related to remote control to the autonomous vehicle based on the DL grant.

It is to be noted that, in FIG. 2, an example in which the initial access process and/or the random access process and the downlink grant reception process of the communication between the autonomous vehicle and the 5G network are combined with each other has been described by way of example via steps S20 to S26, but the present disclosure is not limited thereto.

For example, the initial access process and/or the random access process may be performed through steps S20, S22, S23, S24 and S25. In addition, the initial access process and/or the random access process may be performed through steps S21, S22, S23, S24 and S26. In addition, a process of combining an AI operation and the downlink grant reception process with each other may be performed through steps S23, S24, S25 and S26.

In addition, it is to be noted that, in FIG. 2, an autonomous vehicle operation has been described by way of example through steps S20 to S26, and the present disclosure is not limited thereto.

For example, an autonomous vehicle operation may be realized by selectively combining steps S20, S21, S22 and S25 with steps S23 and S26. In addition, for example, an autonomous vehicle operation may be composed of steps S21, S22, S23 and S26. In addition, for example, an autonomous vehicle operation may be composed of steps S20, S21, S23 and S26. In addition, for example, an autonomous vehicle operation may be composed of steps S22, S23, S25 and S26.

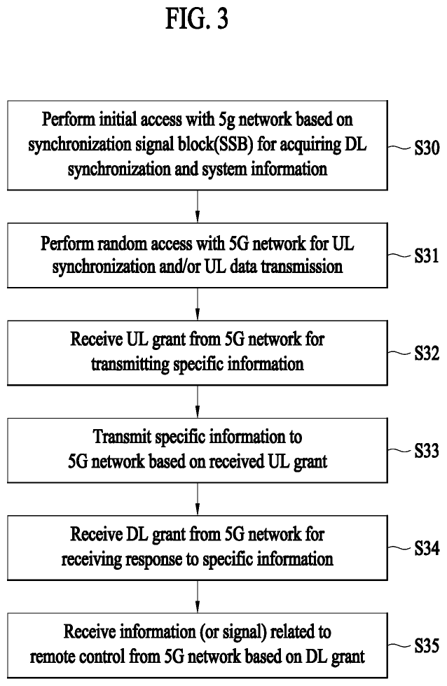

FIGS. 3 to 6 illustrate examples of an autonomous vehicle operation using 5G communication.

First, referring to FIG. 3, in step S30, an autonomous vehicle including an autonomous driving module performs an initial access process with a 5G network based on a synchronization signal block (SSB) to acquire DL synchronization and system information.

In step S31, the autonomous vehicle performs a random access process with the 5G network to acquire UL synchronization and/or to transmit UL data.

In step S32, the autonomous vehicle receives an UL grant from the 5G network in order to transmit specific information.

In step S33, the autonomous vehicle transmits specific information to the 5G network based on the UL grant.

In step S34, the autonomous vehicle receives a DL grant from the 5G network in order to receive a response to the specific information.

In step S35, the autonomous vehicle receives information (or signals) related to remote control from the 5G network based on the DL grant.

A beam management (BM) process may be added to step S30, and a beam failure recovery process related to the transmission of a physical random access channel (PRACH) may be added to step S31. A quasi co-located (QCL) relationship may be added to step S32 with regard to the beam reception direction of a physical downlink control channel (PDCCH). The QCL relationship may also be added to step S33 with regard to the beam transmission direction of a physical uplink control channel (PUCCH) and a physical uplink shared channel (PUSCH). In addition, the QCL relationship may also be added to step S34 with regard to the beam reception direction of a PDCCH including a DL grant.

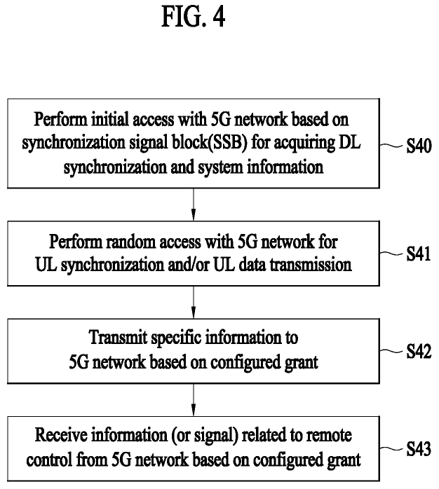

Referring to FIG. 4, in step S40, the autonomous vehicle performs an initial access process with the 5G network based on an SSB to acquire DL synchronization and system information.

In step S41, the autonomous vehicle performs a random access process with the 5G network to acquire UL synchronization and/or to transmit UL data.

In step S42, the autonomous vehicle transmits specific information to the 5G network based on a configured grant.

In step S43, the autonomous vehicle receives information (or signals) related to remote control from the 5G network based on the configured grant.

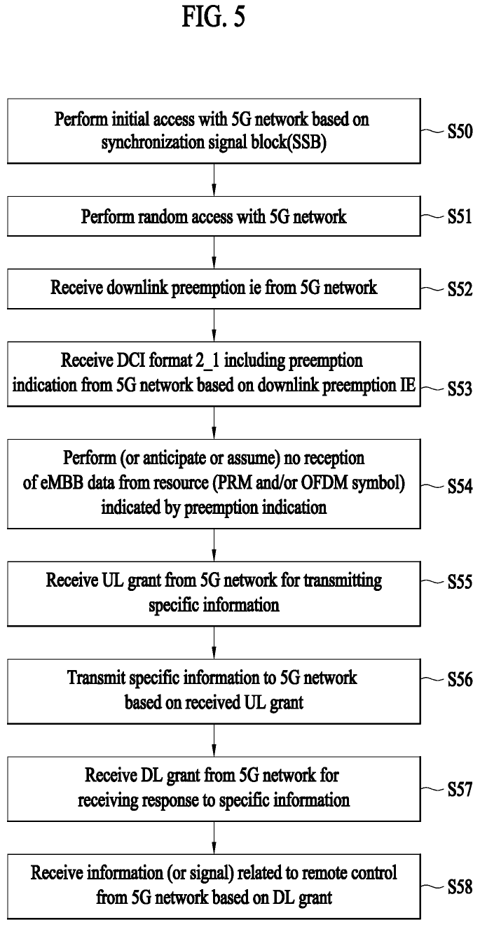

Referring to FIG. 5, in step S50, the autonomous vehicle performs an initial access process with the 5G network based on an SSB to acquire DL synchronization and system information.

In step S51, the autonomous vehicle performs a random access process with the 5G network to acquire UL synchronization and/or to transmit UL data.

In step S52, the autonomous vehicle receives a downlink preemption IE from the 5G network.

In step S53, the autonomous vehicle receives a DCI format 2_1 including a preemption indication from the 5G network based on the downlink preemption IE.

In step S54, the autonomous vehicle does not perform (or anticipate or assume) reception of eMBB data from a resource (PRB and/or OFDM symbols) indicated by the preemption indication.

In step S55, the autonomous vehicle receives an UL grant from the 5G network in order to transmit specific information.

In step S56, the autonomous vehicle transmits specific information to the 5G network based on the UL grant.

In step S57, the autonomous vehicle receives a DL grant from the 5G network in order to receive a response to the specific information.

In step S58, the autonomous vehicle receives information (or signals) related to remote control from the 5G network based on the DL grant.

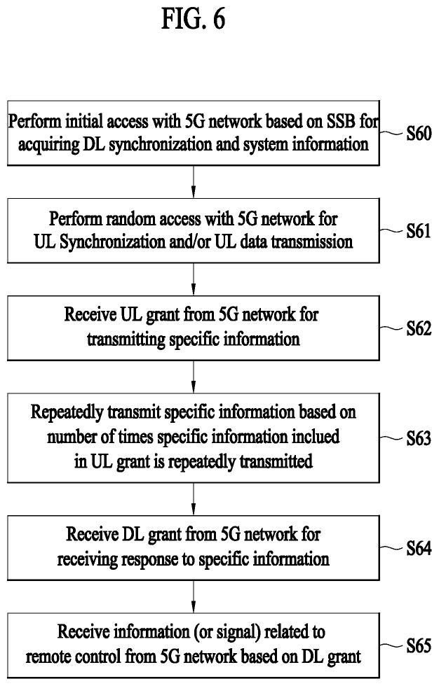

Referring to FIG. 6, in step S60, the autonomous vehicle performs an initial access process with the 5G network based on an SSB to acquire DL synchronization and system information.

In step S61, the autonomous vehicle performs a random access process with the 5G network in order to acquire UL synchronization and/or to transmit UL data.

In step S62, the autonomous vehicle receives an UL grant from the 5G network in order to transmit specific information.

In step S63, the UL grant includes information on the number of times the transmission of specific information is repeated, and the specific information is repeatedly transmitted based on the information on the number of repetition times.

The autonomous vehicle transmits specific information to the 5G network based on the UL grant.

The repetitive transmission of the specific information may be performed through frequency hopping. First transmission of the specific information may be implemented from a first frequency resource, and second transmission of the specific information may be implemented from a second frequency resource.

The specific information may be transmitted through the narrowband of six resource blocks or one resource block.

In step S64, the autonomous vehicle receives a DL grant from the 5G network in order to receive a response to the specific information.

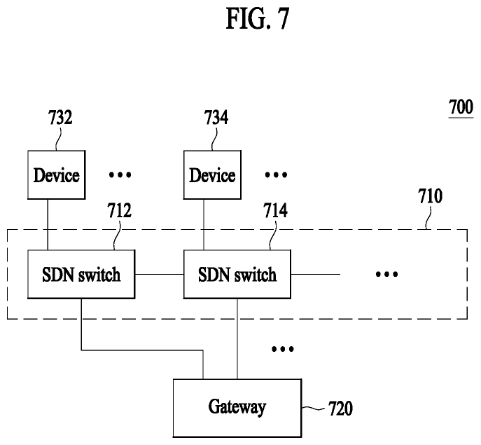

In step S65, the autonomous vehicle receives information (or signals) related to remote control from the 5G network based on the DL grant. The aforementioned 5G communication technology may be applied in combination with the methods proposed herein with reference to FIGS. 7 through 15 or may be complementally used to specify or clarify the technical features of the methods proposed herein.

In addition, herein, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a vehicle equipped with an autonomous driving device which is capable of recognizing the environment around the vehicle and the vehicle condition and thus, controlling the driving of the vehicle. The autonomous vehicle may also be referred to as a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

One or more of a vehicle, a vehicle terminal, and an autonomous vehicle disclosed here may be connected to or converged with an artificial intelligence module, an unmanned aerial vehicle (UAV), a robot, an augmented reality (AR) device, a virtual reality (VR) device, and a 5G service device, for example.

For example, an autonomous vehicle may be operated in connection with at least one artificial intelligence module or robot included in the vehicle.

For example, a vehicle may interact with at least one robot. The robot may be an autonomous mobile robot (AMR) that may move autonomously. The mobile robot is freely movable via an autonomous movement function thereof, and may move to avoid an obstacle through the use of multiple sensors required for avoiding an obstacle during movement. The mobile robot may be a flying robot (for example, a drone) equipped with a flight device. The mobile robot may be a wheeled robot that has at least one wheel and moves via rotation of the wheel. The mobile robot may be a legged robot that has at least one leg and moves using the leg.

A robot may function as a device that supplements user convenience. For example, a robot may function to carry a baggage loaded in a vehicle to a user's final destination. For example, a robot may function to guide a user who got off a vehicle the way to a final destination. For example, a robot may function to transport a user who got off a vehicle to a final destination.

At least one electronic device included in a vehicle may perform communication with a robot via a communication device.

The at least one electronic device included in the vehicle may include a software module or a hardware module (hereinafter referred to as an artificial intelligence module) that realizes artificial intelligence (AI). The at least one electronic device included in the vehicle may input acquired data to the artificial intelligence module and may use data output from the artificial intelligence module.

The artificial intelligence module may perform machine learning on the input data using at least one artificial neural network (ANN). The artificial intelligence module may output driving plan data via the machine learning on the input data.

The at least one electronic device included in the vehicle may generate a control signal based on the data output from the artificial intelligence module.

In some embodiments, the at least one electronic device included in the vehicle may receive data processed by artificial intelligence from an external device through the communication device. The at least one electronic device included in the vehicle may generate a control signal based on the data processed by artificial intelligence. FIG. 7 illustrates a vehicle network apparatus according to the present disclosure.

A vehicle network apparatus 700 may be included in a vehicle and may be a system for controlling the vehicle. The vehicle may be, for example, an autonomous vehicle.

The vehicle network apparatus 700 may be based on a software defined network (SDN). Since the vehicle network apparatus 700 is based on the SDN, the vehicle network apparatus 700 may be more effectively applied to devices using an Ethernet network.

The vehicle network apparatus 700 may include a plurality of SDN switches 710 and a gateway 720. The vehicle network apparatus 700 may further include devices 732 and 734. FIG. 7 illustrates only components of the vehicle network apparatus 700 related to the present embodiment. Therefore, it will be understood by those skilled in the art that other general-purpose components may be further included in addition to the components illustrated in FIG. 7.

The plurality of SDN switches 710 may be switched based on the SDN. The plurality of SDN switches 710 may be connected to the devices 732 and 734 and transmit data of the devices 732 and 734 to a destination. Specifically, the plurality of SDN switches 710 may be connected to one another to form a plurality of routes. The data may be transmitted through the plurality of routes.

The devices 732 and 734 may each be connected to at least one SDN switch among the plurality of SDN switches 710. The devices 732 and 734 may be devices embedded in the vehicle and may be sensors configured to sense information associated with an environment in which the vehicle is located. The devices 732 and 734 may each include, for example, a global positioning system (GPS), an inertial measurement unit (IMU), a radio detection and ranging (RADAR) unit, a light detection and ranging (LIDAR) unit, and a camera, but not be limited thereto. The devices 732 and 734 may be an electronic control unit (ECU) for implementing a preset function. The devices 732 and 734 may each be an input device for inputting data for controlling a vehicle, an output device for outputting an audio signal or a video signal, and a communication device, and also be any electronic device to be embedded in the vehicle. The devices 732 and 734 may be devices including predetermined networks. A first device, for example, the device 732 may include a switch and a sensor.

The gateway 720 may control the plurality of SDN switches 710. The gateway 720 which located at an uppermost position on a network topology of the vehicle network apparatus 700 may include an ECU for implementing a function to control the plurality of SDN switches 710. The gateway 720 may be connected to each of the plurality of SDN switches 710 and communicate with the plurality of SDN switches 710 through OpenFlow to control operations of the plurality of SDN switches 710.

The gateway 720 may monitor the plurality of SDN switches 710. For example, the gateway 720 may monitor current states of the plurality of SDN switches 710 by transmitting a data packet to the plurality of SDN switches 710 and also monitor current states of the devices 732 and 734 based on information stored in the plurality of SDN switches 710.

The gateway 720 may identify a route for transmitting the data of the devices 732 and 734 and control the plurality of SDN switches 710 so that the data of the devices 732 and 734 is transmitted based on the identified route. Specifically, when a destination of the data of the first device 732 is a second device, for example, the device 734, the gateway 730 may control a first SDN switch 712 and a second SDN switch 714 so that the data of the first device 732 is transmitted to the second device 734 by passing through the first SDN switch 712 and the second SDN switch 714.

The gateway 720 may select the route for transmitting the data of the devices 732 and 734 from a plurality of routes formed through a connection between the plurality of SDN switches 710. In an example, the gateway 720 may select the route for transmitting the data of the devices 732 and 734, from the plurality of routes based on states of the plurality of SDN switches 710. The gateway 720 may monitor a state of the first SDN switch 712 and when a bandwidth of the first SDN switch 712 is greater than or equal to an allowable value, the gateway 720 may select a data transmission route not including the first SDN switch 712. In another example, the gateway 720 may select the route for transmitting the data of the devices 732 and 734, from the plurality of routes based on the states of the plurality of SDN switches 710 and states of data of the devices 732 and 734. When the data transmitted by the device 732 is a large amount of data, the gateway 720 may select a route formed by SDN switches capable of transmitting the large amount of data.

Among the plurality of routes, the gateway 720 may change the route for transmitting the data of the devices 732 and 734 from a first route to a second route based on at least one of the states of the data of the devices 732 and 734 and the states of the plurality of SDN switches 710. When the gateway 720 senses that an operation of the first SDN switch 712 is abnormal, the gateway 720 may change a route such that the data transmission route does not include the first SDN switch 712. For example, the gateway 720 may change a route by reprogramming a routing application.

As such, the vehicle network apparatus 700 may identify a route suitable for transmitting data of a device through the gateway 720 functioning as an SDN controller and control the plurality of SDN switches 710 based on the identified route. The vehicle network apparatus 700 may effectively implement a network failover through the gateway 720 and the plurality of SDN switches 710. Since the vehicle network apparatus 700 is based on the SDN, the vehicle network apparatus 700 may easily manage the plurality of SDN switches 710 through the gateway 720 even when an SDN switch is added or a change to another SDN switch is made in the vehicle network apparatus 700. The vehicle network apparatus 700 may change the network topology through the gateway 720 in real time and implement maintenance and repair functions for a routing protocol. The vehicle network apparatus 700 may provide an upgraded vehicle network apparatus through a software update for the plurality of SDN switches 710 and the gateway 720.

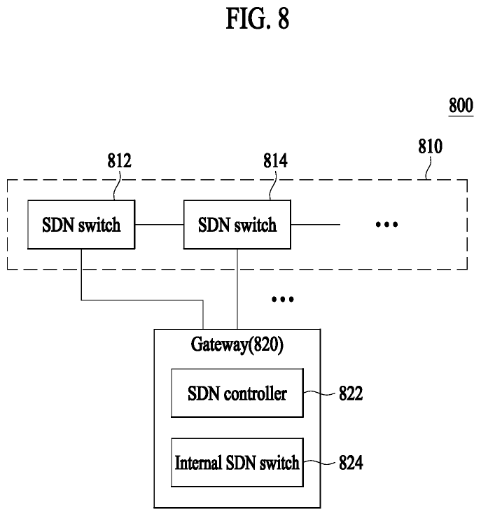

FIG. 8 illustrates an example of a vehicle network apparatus.

A vehicle network apparatus 800 may be based on an SDN and include a plurality of SDN switches 810 and a gateway 820. Since the plurality of SDN switches 810 and the gateway 820 may correspond to the plurality of SDN switches 710 and the gateway 720 of FIG. 7, repeated description will be omitted.

The gateway 820 may be based on the SDN and include an SDN controller 822 and an internal SDN switch 824.

The SDN controller 822 may control the plurality of SDN switches 810. The SDN controller 822 may be implemented through an ECU. The SDN controller 822 may be connected to each of the plurality of SDN switches 810 and communicate with the plurality of SDN switches 810 through OpenFlow to control operations of the plurality of SDN switches 810. For example, the SDN controller 822 may communicate with the plurality of SDN switches 810 through a separate communication network such as a virtual local-area network (VLAN).

The internal SDN switch 824 may be connected to the plurality of SDN switches 810. The internal SDN switch 824 may receive data from the plurality of SDN switches 810 and transmit the data to a predetermined destination. Also, the SDN controller 822 may control the internal SDN switch 824. The internal SDN switch 824 may transmit data under a control of the SDN controller 822. For example, the internal SDN switch 824 may transmit the data to a destination set by the SDN controller 822.

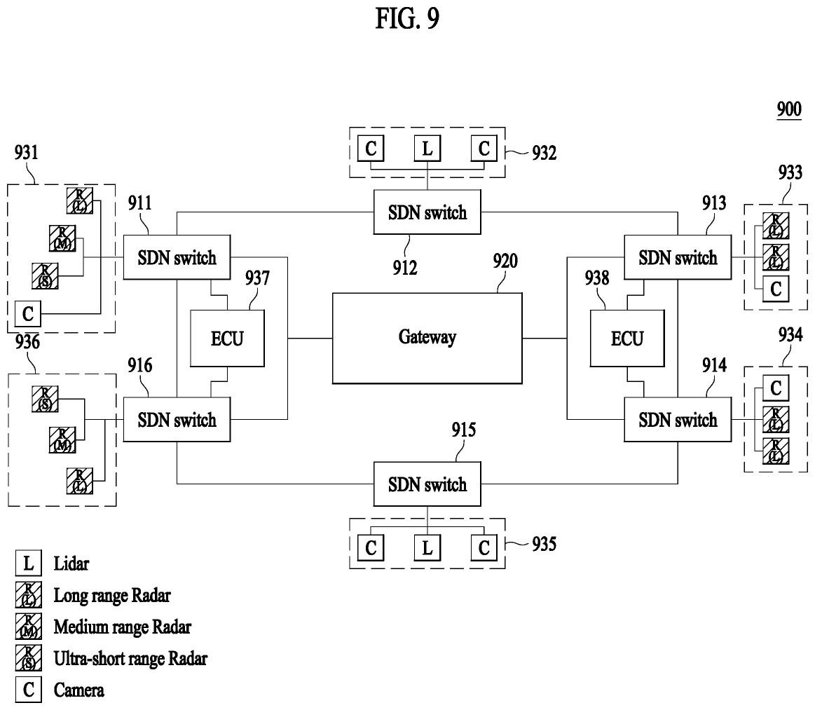

FIG. 9 illustrates another example of a vehicle network apparatus.

A vehicle network apparatus 900 may be based on an SDN and include a plurality of SDN switches 911 through 916 and a gateway 920. Also, the vehicle network apparatus 900 may further include devices 931 through 938. Since the plurality of SDN switches 911 through 916, the gateway 920, and the devices 931 through 938 may correspond to the plurality of SDN switches 710, the gateway 720, and the devices 732 and 734 of FIG. 7, repeated description will be omitted.

Referring to FIG. 9, the gateway 920 may be connected to each of the plurality of SDN switches 911 through 916. The plurality of SDN switches 911 through 916 may be connected to one another. The plurality of SDN switches 911 through 916 may be connected to the devices 931 through 938 and transmit data of the devices 931 through 938 to a destination.

In an example, the SDN switches 911, 912, and 913 may transmit, under a control of the gateway 920, data measured by an ultrashort range radar R(S) among the devices 931 connected to the SDN switch 911 to the device 938 which is an ECU. In other words, the data measured by the ultrashort range radar R(S) may be transmitted to the device 938 which is the ECU by passing the SDN switches 911, 912, and 913. In another example, the SDN switches 915 and 916 may transmit, under the control of the gateway 920, data measured by a camera C of the devices 935 connected to the SDN switch 915, to the device 937 which is an ECU.

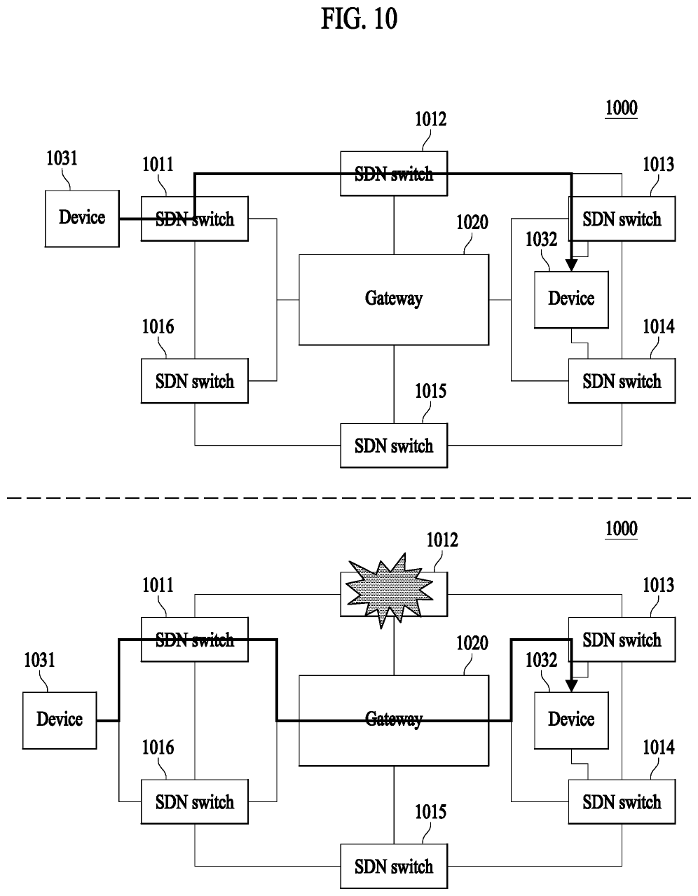

FIG. 10 illustrates an example of a gateway changing a data transmission route.

A vehicle network apparatus 1000 may include a plurality of SDN switches 1011 through 1016 and a gateway 1020. Also, the vehicle network apparatus 1000 may further include a plurality of devices, for example, devices 1031 and 1032. Since the plurality of SDN switches 1011 through 1016, the gateway 1020, and the devices 1031 and 1032 may correspond to the plurality of SDN switches 710, the gateway 720, and the devices 732 and 734 of FIG. 7, repeated description will be omitted.

Referring to an upper part of FIG. 10, the gateway 1020 may identify a route passing the SDN switches 1011, 1012, and 1013 to be a route for transmitting data of the device 1031 to the device 1032. The gateway 1020 may control the SDN switches 1011, 1012, and 1013, thereby transmitting the data of the device 1031 to the device 1032.

The gateway 1020 may identify a state of the SDN switch 1012 and change the route for transmitting the data of the device 1031. Specifically, the gateway 1020 may monitor states of the plurality of SDN switches 1011 through 1016 and verify that the state of the SDN switch 1012 is not suitable for transmitting the data. For example, the gateway 1020 may verify an overload of the SDN switch 1012.

Referring to a lower part of FIG. 10, the gateway 1020 may change the route for transmitting the data of the device 1031 to a route passing the SDN switch 1011, the gateway 1020, and the SDN switch 1013. In other words, the gateway 1020 may change a data transmission route from the route illustrated in the upper part of FIG. 10 to the route illustrated in the lower part of FIG. 10. The gateway 1020 may control the SDN switch 1011, an internal SDN switch of the gateway 1020, and the SDN switch 1013, thereby transmitting the data of the device 1031 to the device 1032.

As such, the vehicle network apparatus 1000 may change a data transmission route based on a state of an SDN switch in real time and effectively implement a network redundancy for failover.

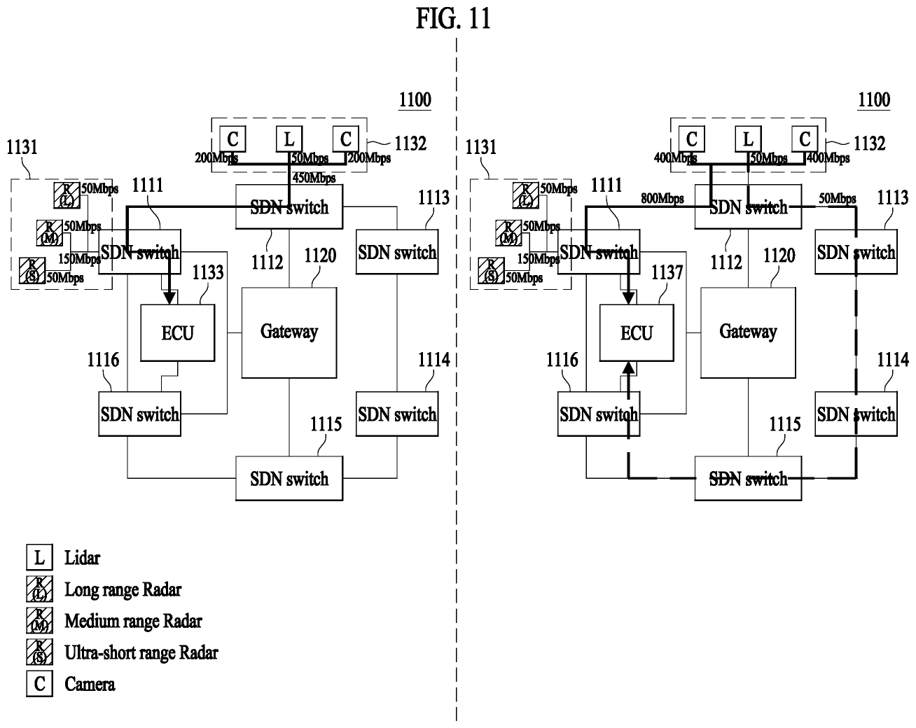

FIG. 11 illustrates another example of a gateway changing a data transmission route.

A vehicle network apparatus 1100 may include a plurality of SDN switches 1111 through 1116 and a gateway 1120. Also, the vehicle network apparatus 1100 may further include a plurality of devices, for example, devices 1131 through 1133. Since the plurality of SDN switches 1111 through 1116, the gateway 1120, and the devices 1131 through 1133 may correspond to the plurality of SDN switches 710, the gateway 720, and the devices 732 and 734 of FIG. 7, repeated description will be omitted.

Referring to a left part of FIG. 11, the gateway 1120 may identify a route passing the SDN switches 1111 and 1112 to be a route for transmitting data of the devices 1131 to the device 1133 which is an ECU. Specifically, the gateway 1120 may transmit data of two cameras C and a lidar L included in the devices 1121 to the device 1133 which the ECU through the SDN switches 1111 and 1112.

The gateway 1120 may identify states of data of the devices 1132 and change the route for transmitting the data of the devices 1132. Specifically, the gateway 1120 may verify that the two cameras C of the devices 1132 are to transmit a large amount of data. For example, the two cameras C may increase a data transmission rate from 200 megabits per second (Mbps) to 400 Mbps to transmit the large amount of data. In this instance, the two cameras C may transmit information indicating that the large amount of data is to be transmitted, to the gateway 1120. The gateway 1120 may change a route for transmitting data of the two cameras C of the devices 1132 based on a bandwidth allowance of each of the SDN switches 1111 and 1112. For example, when the bandwidth allowance of each of the SDN switches 1111 and 1112 is 1000 Mbps, the SDN switch 1111 may not additionally transmit data having 800 Mbps of the two cameras C of the devices 1132 because the SDN switch is transmitting data having 150 Mbps of the devices 1131. Thus, the gateway 1120 may change the route for transmitting the data of the two cameras C of the devices 1132 to achieve load balancing. Also, when the bandwidth allowance of the SDN switch is exceeded, the gateway 1120 may announce or store information associated with a bandwidth of the SDN switch.

Referring to a right part of FIG. 11, the gateway 1120 may change the route for transmitting the data of the two cameras C of the devices 1132 to a route passing the SDN switches 1112, 1113, 1114, 1115, and 1116. In other words, the gateway 1120 may change a route for transmitting the data of the two cameras C of the devices 1132 from the route illustrated in the left part of FIG. 11 to the route illustrated in the right part of FIG. 11. Also, the gateway 1120 may maintain the route passing the SDN switches 1111 and 1112 as a route for transmitting data of the lidar L of the devices 1132. When the transmission of the large amount of data of the two cameras C is completed, the gateway 1120 may change the route for transmitting the data of the two cameras C from the route in the left part of FIG. 11 to the route in the right part of FIG. 11. In this case, the two cameras C may transmit information indicating that the transmission of the large amount of data is completed, to the gateway 1120.

As such, the vehicle network apparatus 1100 may change a data transmission route based on a state of an SDN switch in real time and effectively implementing the load balancing.

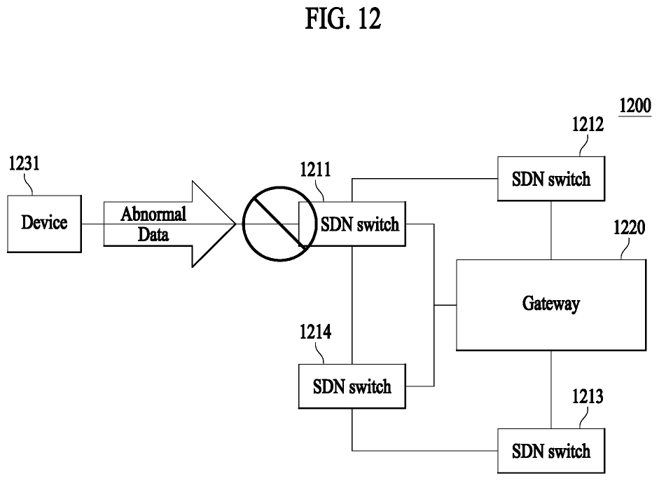

FIG. 12 illustrates an example of a gateway blocking data of a device.

A vehicle network apparatus 1200 may include a plurality of SDN switches 1211 through 1214 and a gateway 1220. The vehicle network apparatus 1200 may further include a device 1231. Since the plurality of SDN switches 1211 through 1214, the gateway 1220, and the device 1231 may correspond to the plurality of SDN switches 710, the gateway 720, and the devices 732 and 734 of FIG. 7, repeated description will be omitted.

The gateway 1220 may monitor the plurality of SDN switches 1211 through 1214 to verify whether abnormal data is transmitted to the plurality of SDN switches 1211 through 1214. Also, the gateway 1220 may monitor the device 1231 to verify whether abnormal data is transmitted from the device 1231 to the SDN switch 1211. As an example, due to malfunctioning or defection of the device 1231, abnormal data may be transmitted to the SDN switch 1211. As another example, due to traffic storm occurring in the device 1231, abnormal data may be transmitted to the SDN switch 1211.

When the abnormal data is transmitted to the SDN switch 1211, the gateway 1220 may block the abnormal data using the SDN switch 1211. For example, the gateway 1220 may control a port of the SDN switch 1211 to be in a disabled state, so that the abnormal data does not pass the SDN switch 1211.

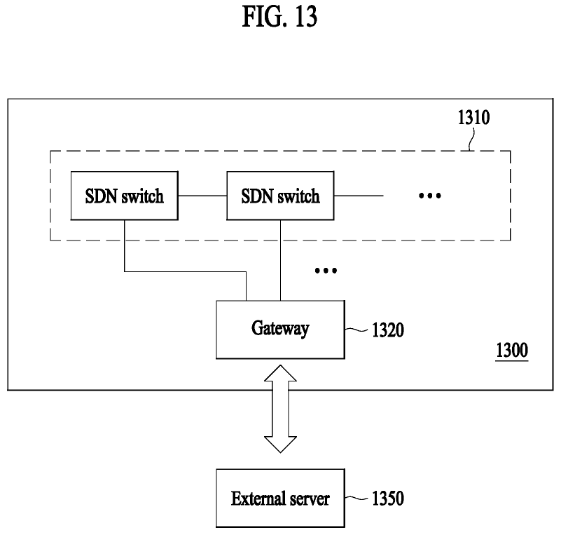

FIG. 13 illustrates an example of a gateway communicating with an external network.

A vehicle network apparatus 1300 may include a plurality of SDN switches 1310 and a gateway 1320. Since the plurality of SDN switches 1310 and the gateway 1320 may correspond to the plurality of SDN switches 710 and the gateway 720 of FIG. 7, repeated description will be omitted.

The gateway 1320 may communicate with an external server 1350. The gateway 1320 may communicate with the external server 1350 to receive data from the external server 1350 or transmit data to the external server 1350. For example, the gateway 1320 may perform a 5G network access process in association with the external server 1350. The gateway 1320 may perform the 5G network access process illustrated in FIGS. 1 through 6. The gateway 1320 may be connected to the external server 1350 through a 5G network and thus, may transmit data to the external server 1350 based on an uplink grant or receive data from the external server 1350 based on a downlink grant. In an example, the gateway 1320 may connect the vehicle network apparatus 1300 corresponding to an Ethernet network and an external Ethernet network.

The gateway 1320 may verify whether the data transmitted from the external server 1350 is abnormal data. The gateway 1320 may verify whether a data packet abnormally repeated due to, for example, a distributed denial of service (DDoS) attack is transmitted from the external server 1350.

When the abnormal data is transmitted from the external network, the gateway 1320 may block the abnormal data such that the abnormal data is not transmitted into the vehicle network apparatus 1300. For example, the gateway 1320 may control a port of an SDN switch in the gateway 1320 to be in a disabled state, thereby blocking the abnormal data.

As such, the vehicle network apparatus 1300 may block abnormal external data using the gateway 1320 located at an uppermost position on a network topology, thereby implementing a more effective firewall.

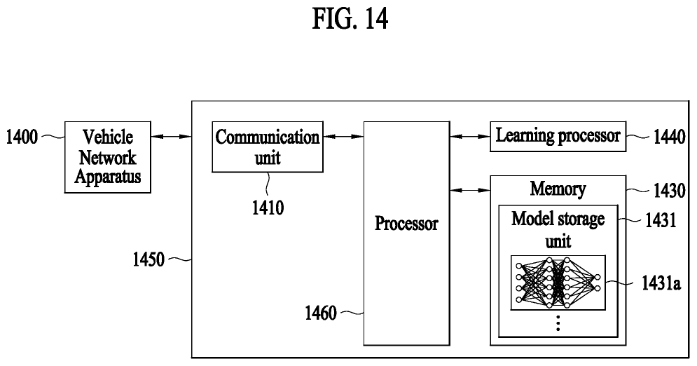

FIG. 14 illustrates an example of a vehicle network apparatus communicating with an AI server.

Since a vehicle network apparatus 1400 may correspond to the vehicle network apparatuses 700 through 1300 of FIGS. 7 through 13, repeated description will be omitted.

The vehicle network apparatus 1400 may communicate with an AI server 1450 to receive data from the AI server 1450 and transmit data to the AI server 1450.

The vehicle network apparatus 1400 may receive information associated with a route for transmitting data of a device from the AI server 1450 and transmit the data of the device by controlling SDN switches based on the received information. Specifically, the vehicle network apparatus 1400 may transmit information associated with devices and a plurality of SDN switches to the AI server 1450. The AI server 1450 may identify a route for transmitting data of a device. The vehicle network apparatus 1400 may control SDN switches based on the route received from the AI server 1450, thereby transmitting the data of the device.

The AI server 1450 may refer to a device that trains an artificial neural network using a machine learning algorithm or uses the trained artificial neural network. For example, the AI server 1450 may determine a data transmission route of the vehicle network apparatus 1400 using a trained artificial neural network. The AI server 1450 may be constituted of multiple servers to perform distributed processing and may be defined as a 5G network. At this time, the AI server 1450 may be included as an element of the vehicle network apparatus 1400 so as to perform at least a part of AI processing together with the vehicle network apparatus 1400.

The AI server 1450 may include a communication unit 1410, a memory 1430, a learning processor 1440, and a processor 1460.

The communication unit 1410 may transmit and receive data to and from an external device such as the vehicle network apparatus 1400.

The memory 1430 may include a model storage unit 1431. The model storage unit 1431 may store a model (or an artificial neural network 1431a) which is learning or has learned via the learning processor 1440.

The learning processor 1440 may train the artificial neural network 1431a using learning data. A learning model may be used in the state of being mounted in the AI server 1450 of the artificial neural network or may be used in the state of being mounted in an external device such as the vehicle network apparatus 1400.

The learning model may be realized in hardware, software, or a combination of hardware and software. In the case in which a part or the entirety of the learning model is realized in software, one or more instructions constituting the learning model may be stored in the memory 1430.

The processor 1460 may deduce a result value for newly input data using the learning model and may generate a response or a control instruction based on the deduced result value.

Accordingly, instead of the vehicle network apparatus 1400, the AI server 1450 may perform computation for identifying a data transmission route of a device. Also, the vehicle network apparatus 1400 may control a plurality of SDN switches based on the data transmission route identified by the AI server 1450. Through this, a computational load of the vehicle network apparatus 1400 may be reduced.

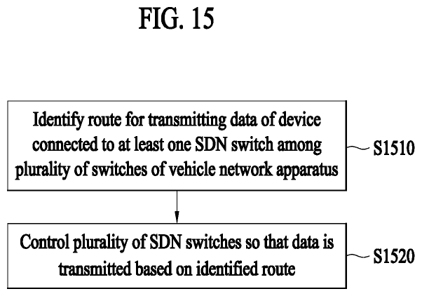

FIG. 15 illustrates an operation method of a vehicle network apparatus according to the present disclosure.

The operation method of FIG. 15 may be performed by each of the elements of the vehicle network apparatuses 700 through 1400 of FIGS. 7 through 14, repeated description will be omitted.

In operation S1510, the vehicle network apparatuses 700 through 1400 may identify a route for transmitting data of a device connected to at least one SDN switch among a plurality of switches of each of the corresponding vehicle network apparatus.

The vehicle network apparatuses 700 through 1400 may identify a route suitable for transmitting the data of the device among a plurality of routes formed through a connection between the plurality of SDN switches. The vehicle network apparatuses 700 through 1400 may identify a route for transmitting the data of the device, based on at least one of states of the plurality of SDN switches and a state of the data of the device.

In operation S1520, the vehicle network apparatuses 700 through 1400 may control the plurality of SDN switches so that the data is transmitted based on the route identified in operation S1510.

The vehicle network apparatuses 700 through 1400 may transmit, to the plurality of SDN switches, information associated with the route identified in operation S1510 through OpenFlow. The plurality of SDN switches may transmit the data based on the information associated with the identified route.

The vehicle network apparatuses 700 through 1400 may determine whether the data of the device is abnormal data. When the data of the device is the abnormal data, the vehicle network apparatuses 700 through 1400 may control a port in the at least one SDN switch to be in a disabled state such that the abnormal data does not pass the at least one SDN switch.

The vehicle network apparatuses 700 through 1400 may perform a 5G network access process in association with an external server and may receive data from the external server based on a downlink grant or transmit data to the external server based on an uplink grant.

The vehicle network apparatuses 700 through 1400 may determine whether data transmitted from the external server is abnormal data. When the data transmitted from the external server is the abnormal data, the vehicle network apparatuses 700 through 1400 may control a port in an SDN switch in a gateway of the corresponding vehicle network apparatuses 700 through 1400 to be in a disabled state such that the abnormal data does not pass the gateway.

The vehicle network apparatuses 700 through 1400 may transmit information associated with the plurality of SDN switches and information associated with the data of the device to an external AI server and receive, from the external AI server, information associated with the route for transmitting the data of the device.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer readable recording medium as computer readable codes or program commands which may be executed by the processor. Here, the computer readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer readable recording medium may be dispersed to computer systems connected by a network so that computer readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

What is claimed is:

1. A software defined network (SDN)-based vehicle network apparatus comprising:
a plurality of SDN switches; and
a gateway configured to identify a route for transmitting data of a device connected to at least one SDN switch among the plurality of switches and control the plurality of SDN switches so that the data is transmitted based on the identified route.

2. The SDN-based vehicle network apparatus of claim 1, wherein the gateway is configured to transmit, to the plurality of SDN switches, information associated with the identified route through OpenFlow and
the plurality of SDN switches transmits the data based on the information associated with the identified route.

3. The SDN-based vehicle network apparatus of claim 1, wherein the gateway is configured to identify a route suitable for transmitting the data among a plurality of routes formed through a connection between the plurality of SDN switches.

4. The SDN-based vehicle network apparatus of claim 1, wherein the gateway is configured to identify a route for transmitting the data of the device, based on at least one of states of the plurality of SDN switches and a state of the data of the device.

5. The SDN-based vehicle network apparatus of claim 1, wherein the gateway is configured to determine whether the data of the device is abnormal data and when the data of the device is the abnormal data, control a port in the at least one SDN switch to be in a disabled state such that the abnormal data does not pass the at least one SDN switch.

6. The SDN-based vehicle network apparatus of claim 1, wherein the gateway is configured to perform a fifth generation cellular network technology (5G) network access process in association with an external server, and receive data from the external server based on a downlink grant or transmit data to the external server based on an uplink grant.

7. The SDN-based vehicle network apparatus of claim 1, wherein the gateway is configured to determine whether data transmitted from an external server is abnormal data and when the data transmitted from the external server is the abnormal data, control a port of an SDN switch in the gateway to be in a disabled state such that the abnormal data does not pass the gateway.

8. The SDN-based vehicle network apparatus of claim 1, wherein the gateway is configured to transmit information associated with the plurality of SDN switches and information associated with the data of the device to an external artificial intelligence (AI) server and receive, from the external AI server, information associated with the route for transmitting the data of the device.

9. An operation method of a software defined network (SDN)-based vehicle network apparatus, the method comprising:
identifying a route for transmitting data of a device connected to at least one SDN switch among a plurality of switches in the SDN-based vehicle network apparatus; and
controlling the plurality of SDN switches so that the data is transmitted based on the identified route.

10. The operation method of claim 9, wherein the controlling comprises transmitting, to the plurality of SDN switches, information associated with the identified route through OpenFlow and
the plurality of SDN switches transmits the data based on the information associated with the identified route.

11. The operation method of claim 9, wherein the identifying comprises identifying a route suitable for transmitting the data among a plurality of routes formed through a connection between the plurality of SDN switches.

12. The operation method of claim 9, wherein the identifying comprises identifying a route for transmitting the data of the device, based on at least one of states of the plurality of SDN switches and a state of the data of the device.

13. The operation method of claim 9, further comprising:
determining whether the data of the device is abnormal data; and
controlling, when the data of the device is the abnormal data, a port in the at least one SDN switch to be in a disabled state such that the abnormal data does not pass the at least one SDN switch.

14. The operation method of claim 9, further comprising:
performing a fifth generation cellular network technology (5G) network access process in association with an external server; and
receiving data from the external server based on a downlink grant or transmit data to the external server based on an uplink grant.

15. The operation method of claim 9, further comprising:
determining whether data transmitted from an external server is abnormal data; and
controlling, when the data transmitted from the external server is the abnormal data, a port of an SDN switch in a gateway of the SDN-based vehicle network apparatus to be in a disabled state such that the abnormal data does not pass the gateway.

16. The operation method of claim 9, further comprising:
transmitting information associated with the plurality of SDN switches and information associated with the data of the device to an external artificial intelligence (AI) server; and
receiving, from the external AI server, information associated with the route for transmitting the data of the device.

17. A non-transitory computer-readable storage medium storing programs to execute the operation method of claim 9.
